(19) United States
(12) Patent Application Publication
(10) Pub. No.: US 2026/0018828 A1
(43) Pub. Date: Jan. 15, 2026

(54) FIRST CONNECTOR, AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuta KANEMATSU, Mie (JP); Sunghyun BYUN, Mie (JP); Nobukazu HIROWAKI, Mie (JP)

(21) Appl. No.: 18/880,845

(22) PCT Filed: Jun. 26, 2023
(86) PCT No.: PCT/JP2023/023450

§ 371 Date: Jan. 3, 2025

(30) Foreign Application Priority Data
Jul. 8, 2022 (JP) 2022-110671

(51) Int. Cl. H01R 13/621

(52) U.S. Cl. CPC H01R 13/621

(57) ABSTRACT

A first connector includes a first terminal, a first housing, a fastening bolt and a bolt insertion hole penetrating through the first housing. The fastening bolt is displaceable with respect to the bolt insertion hole between an initial position and a connection start position. The fastening bolt is arranged at the initial position by a tip of a bolt-side screw portion contacting an opening of a nut and displaced to the connection start position by the bolt-side screw portion of the fastening bolt being threadably engaged with a nut-side screw portion provided in the nut in a state where the first connector is temporarily fixed to a second connector and no contact pressure is generated between the first terminal and a second terminal.

### TECHNICAL FIELD

The present disclosure relates to a first connector and a connector assembly.

### BACKGROUND

Conventionally, in a connector assembly used in power transmission between in-vehicle devices such as a high voltage battery and an inverter, a contact pressure between terminals respectively accommodated in a first connector and a second connector is increased to prevent fine sliding wear between the terminals. In response to large currents and high voltages of recent years, terminals have been enlarged and wires to be connected to terminal fittings have been enlarged in diameter and a contact pressure between the terminals has increased. Thus, a connection force required in connecting the first and second connectors may increase and it may become difficult to manually connect the first and second connectors by a worker.

Accordingly, in Patent Document 1, a connector assembly of a so-called bolt assist type is proposed which enables the connection of connectors, utilizing fastening forces of bolts, by bolting the first connector to the second connector.

### PRIOR ART DOCUMENT

### Patent Document

Patent Document 1: JP 2018-041635 A

### SUMMARY OF THE INVENTION

### Problems to be Solved

In the connector assembly of Patent Document 1, since the contact pressure between the terminal of the first connector and the terminal of the second connector is applied at the same time as the first screw thread of a fastening bolt provided in the first connector is engaged with the first screw thread of a nut provided in the second connector in bolting the first connector to the second connector, the rigidity of the screw threads may not withstand the contact pressure and the screw threads may be broken.

In response to this problem, it may be thought to increase an engagement length of the screw threads of the fastening bolt and the nut in applying the contact pressure between the terminals merely by making the fastening bolt longer. However, the fastening bolt projecting long may interfere with another member at the time of connecting the connectors to hinder a connecting operation itself, wherefore a more appropriate measure has been required.

Accordingly, a first connector and a connector assembly are disclosed which can increase an engagement length of screw threads of a fastening bolt and a nut before a contact pressure between terminals is applied without making the fastening bolt longer.

### Means to Solve the Problem

A first connector of the present disclosure is to be detachably connected to a second connector and provided with a first terminal to be connected to a second terminal provided in the second connector, a first housing for accommodating and holding the first terminal and a fastening bolt held in the first housing, the fastening bolt being fastened to a nut provided in the second connector, the first housing including a bolt insertion hole penetrating through the first housing in a connection direction of the first connector to the second connector, the fastening bolt including a bolt head portion, an inserting shaft portion projecting forward in the connection direction from the bolt head portion and to be inserted into the bolt insertion hole, a bolt-side screw portion projecting forward in the connection direction from a tip of the inserting shaft portion and an engaging protrusion located on the tip side of the inserting shaft portion and projecting toward an outer peripheral side of the fastening bolt, the bolt insertion hole including a front opening open forward in the connection direction and a rear opening open rearward in the connection direction, the fastening bolt being displaceable by a predetermined dimension in the connection direction with respect to the bolt insertion hole between an initial position where a rearward displacement in the connection direction is restricted by the engaging protrusion engaging a front peripheral edge part, the front peripheral edge part being a peripheral edge part of the front opening, and a connection start position where a forward displacement in the connection direction is restricted by the bolt head portion engaging a rear peripheral edge part, the rear peripheral edge part being a peripheral edge part of the rear opening, the fastening bolt being inseparably assembled, and the fastening bolt being arranged at the initial position by a tip of the bolt-side screw portion contacting an opening of the nut and displaced to the connection start position by the bolt-side screw portion of the fastening bolt being threadably engaged with a nut-side screw portion provided in the nut in a state where the first connector is temporarily fixed to the second connector and no contact pressure is generated between the first terminal and the second terminal.

A connector assembly of the present disclosure is provided with the first connector of the present disclosure and a second connector to be detachably connected to the first connector, the second connector including a second terminal to be connected to the first terminal, a second housing for accommodating and holding the second terminal and a nut to be fastened to the fastening bolt.

### Effect of the Invention

According to a first connector and a connector assembly of the present disclosure, it is possible to increase an engagement length of screw threads of a fastening bolt and a nut before a contact pressure between terminals is applied without making the fastening bolt longer.

### BRIEF DESCRIPTION OF THE DRAWINGS

FIG. 1 is a perspective view showing a connector assembly according to a first embodiment in a connected state of a first connector and a second connector.

FIG. 2 is a plan view of the connector assembly shown in FIG. 1.

FIG. 3 is a vertical section enlargedly showing an essential part in a cross-section along III-III in FIG. 2.

FIG. 4 is a vertical section enlargedly showing an essential part in a cross-section along IV-IV in FIG. 2.

FIG. 5 is a vertical section enlargedly showing an essential part in a cross-section along V-V in FIG. 4.

FIG. 6 is a perspective view of the connector assembly shown in FIG. 1 in a disassembled state of the first and second connectors.

FIG. 7 is a vertical section, corresponding to FIG. 3, showing a state where a fastening bolt is at an initial position in the connector assembly shown in FIG. 1.

FIG. 8 is a vertical section, corresponding to FIG. 3, showing a state where the fastening bolt is at a connection start position in the connector assembly shown in FIG. 1.

FIG. 9 is a vertical section, corresponding to FIG. 4, showing the state where the fastening bolt is at the connection start position.

FIG. 10 is a bottom view showing the first connector constituting the connector assembly shown in FIG. 1.

FIG. 11 is a perspective view showing the second connector constituting the connector assembly shown in FIG. 1.

FIG. 12 is a vertical section, corresponding to FIG. 3, showing a first connector according to a second embodiment.

### DETAILED DESCRIPTION TO EXECUTE THE INVENTION

### Description of Embodiments of Present Disclosure

First, embodiments of the present disclosure are listed and described.

(1) The first connector of the present disclosure is to be detachably connected to a second connector and provided with a first terminal to be connected to a second terminal provided in the second connector, a first housing for accommodating and holding the first terminal and a fastening bolt held in the first housing, the fastening bolt being fastened to a nut provided in the second connector, the first housing including a bolt insertion hole penetrating through the first housing in a connection direction of the first connector to the second connector, the fastening bolt including a bolt head portion, an inserting shaft portion projecting forward in the connection direction from the bolt head portion and to be inserted into the bolt insertion hole, a bolt-side screw portion projecting forward in the connection direction from a tip of the inserting shaft portion and an engaging protrusion located on the tip side of the inserting shaft portion and projecting toward an outer peripheral side of the fastening bolt, the bolt insertion hole including a front opening open forward in the connection direction and a rear opening open rearward in the connection direction, the fastening bolt being displaceable by a predetermined dimension in the connection direction with respect to the bolt insertion hole between an initial position where a rearward displacement in the connection direction is restricted by the engaging protrusion engaging a front peripheral edge part, the front peripheral edge part being a peripheral edge part of the front opening, and a connection start position where a forward displacement in the connection direction is restricted by the bolt head portion engaging a rear peripheral edge part, the rear peripheral edge part being a peripheral edge part of the rear opening, the fastening bolt being inseparably assembled, and the fastening bolt being arranged at the initial position by a tip of the bolt-side screw portion contacting an opening of the nut and displaced to the connection start position by the bolt-side screw portion of the fastening bolt being threadably engaged with a nut-side screw portion provided in the nut in a state where the first connector is temporarily fixed to the second connector and no contact pressure is generated between the first terminal and the second terminal.

According to the first connector of the present disclosure, the fastening bolt provided in the first connector is displaceable from the initial position to the connection start position with respect to the bolt insertion hole in the state where the first connector is temporarily fixed to the second connector and no contact pressure is generated between the first terminal and the second terminal. At the initial position, the bolt head portion is separated rearward in the connection direction of the first and second connectors by the predetermined dimension from the rear opening of the bolt insertion hole. At the connection start position, the bolt head portion has moved the predetermined dimension toward the rear peripheral edge part by threadably engaging the bolt-side screw portion of the fastening bolt with the nut-side screw portion. That is, at the connection start position before a contact pressure between the first and second terminals is generated, the bolt-side screw portion of the fastening bolt can be already threadably engaged with the nut-side screw portion of the second connector and the fastening bolt can be moved forward in the connection direction by the predetermined dimension. In this way, screw threads of the bolt-side screw portion can be engaged with those of the nut-side screw portion while the fastening bolt is moving the predetermined dimension in the connection direction, and an engagement length of the screw threads of the fastening bolt and the nut can be increased before the contact pressure of the first and second terminals is exerted. Therefore, even if the contact pressure of the first and second terminals is exerted, the breakage of the screw threads of the fastening bolt is suppressed and the durability of the first connector is improved.

Further, by adopting a configuration for making the fastening bolt displaceable with respect to the bolt insertion hole by the predetermined dimension in the connection direction and an opposite direction, the engagement length of the screw threads of the fastening bolt and the nut can be increased. Thus, the fastening bolt itself needs not be made longer, wherefore the deterioration of assemblability of the first connector with the second connector is suppressed or prevented.

Note that the first housing may be constituted by an insulating first connector housing or may include a shield shell made of metal and to be fixedly assembled with the first connector housing while covering the first connector housing. Further, the bolt insertion hole, into which the fastening bolt is inserted, only has to be provided in the first housing. Thus, the bolt insertion hole may be provided in the first connector housing or may be provided in the shield shell if the first connector housing is covered by the shield shell.

Further, an arbitrary configuration can be adopted as a configuration for “temporarily fixing the first connector to the second connector” if the first and second connectors are positioned to be connectable to each other in the connection direction.

(2) Preferably, the first housing includes an insulating first connector housing and a shield shell made of metal and to be fixedly assembled with the first connector housing while covering the first connector housing, and the bolt insertion hole is provided in the shield shell. Since the rear peripheral edge part of the bolt insertion hole, to which a fastening force of the bolt insertion hole is exerted, can be configured utilizing the shield shell made of metal, necessity to specially reinforce the rear peripheral edge part can be reduced and the rigidity of the rear peripheral edge part can be ensured with a small number of components.

(3) Preferably, the engaging protrusion of the fastening bolt is non-displaceably provided, a recess open in the connection direction is provided in the front peripheral edge part of the bolt insertion hole and a depth of the recess is set to the predetermined dimension, and the fastening bolt is arranged at the initial position by the engaging protrusion contacting a bottom surface of the recess and the fastening bolt is arranged at the connection start position by the engaging protrusion being displaced toward an opening side of the recess and the bolt head portion contacting the rear peripheral edge part.

The engaging protrusion is fixedly provided on the fastening bolt, and the fastening bolt can be inserted into the bolt insertion hole displaceably in the connection direction and the opposite direction by providing the recess open in the connection direction in the front peripheral edge part of the bolt insertion hole. By setting the depth of the recess to the predetermined dimension and bringing the engaging protrusion into contact with the bottom surface of the recess, the fastening bolt can be easily and reliably arranged at the initial position. Further, since the fastening bolt is arranged at the connection start position by displacing the engaging protrusion toward the opening side of the recess and bringing the bolt head portion into contact with the rear peripheral edge part, the fastening bolt can be easily and reliably arranged at the connection start position. Moreover, since the bolt head portion is in contact with the rear peripheral edge part at the connection start position, a fastening force of the bolt can be quickly transmitted toward the first housing and the first and second connectors can be advantageously connected utilizing the fastening force of the bolt when the fastening bolt is further fastened from the connection start position.

(4) Preferably, an annular ring mounting groove open toward the outer peripheral side is provided on the tip side of the inserting shaft portion of the fastening bolt, a ring member made of metal and cut in one place in a circumferential direction is mounted displaceably in the connection direction into the ring mounting groove to configure the engaging protrusion, the first connector is temporarily fixed to the second connector and the tip of the bolt-side screw portion contacts the opening of the nut, whereby the ring member is locked to a front end surface in the connection direction of the ring mounting groove on the fastening bolt arranged at the initial position, and the ring member moves toward a rear end surface in the connection direction of the ring mounting groove and the bolt head portion contacts the rear peripheral edge part on the fastening bolt threadably engaged with the nut and arranged at the connection start position.

Only by providing the ring mounting groove on the tip side of the inserting shaft portion of the fastening bolt and assembling the ring member made of metal with the ring mounting groove displaceably in the connection direction, the fastening bolt allowed to be displaced by the predetermined dimension with respect to the bolt insertion hole from the initial position to the connection start position can be inseparably assembled. Therefore, the configuration of the present disclosure can be realized, manufacturability can be improved and cost can be reduced without requiring a change in the shape of the first connector.

Note that the ring member made of metal may be anything if the ring member is cut in one place in the circumferential direction and can be mounted into the ring mounting groove. For example, a known C-ring, E-ring or the like can be advantageously adopted.

(5) Preferably, the fastening bolt is displaced to a connection completion position located forward in the connection direction by further threadably engaging the bolt-side screw portion with the nut-side screw portion from the connection start position, and the first connector is completely fixed to the second connector with the fastening bolt arranged at the connection completion position. By further threadably engaging the fastening bolt with the nut from the connection start position to the connection completion position, the first connector can be completely connected to the second connector, utilizing an assist force obtained by bolt fastening. Particularly, since the threadable engagement of the fastening bolt and the nut is already completed by a predetermined displacement of the fastening bolt in the connection direction at the connection start position, the contact pressure of the first and second terminals generated at the time of connecting the first and second connectors can be stably received by the fastening bolt and the nut, the breakage of the screw threads of the fastening bolt is suppressed and the durability of the first connector is improved.

(6) The connector assembly of the present disclosure is provided with the first connector of the present disclosure and a second connector to be detachably connected to the first connector, the second connector including a second terminal to be connected to the first terminal, a second housing for accommodating and holding the second terminal and a nut to be fastened to the fastening bolt.

According to the connector assembly of the present disclosure, since the first connector of the present disclosure is adopted as the first connector to be connected to the second connector, the connector assembly can be provided which can enjoy functions and effects similar to those of the first connector.

### Details of Embodiments of Present Disclosure

Specific examples of a first connector and a connector assembly of the present disclosure are described below with reference to the drawings. Note that the present disclosure is not limited to these illustrations, but is represented by claims and intended to include all changes in the scope of claims and in the meaning and scope of equivalents.

### First Embodiment

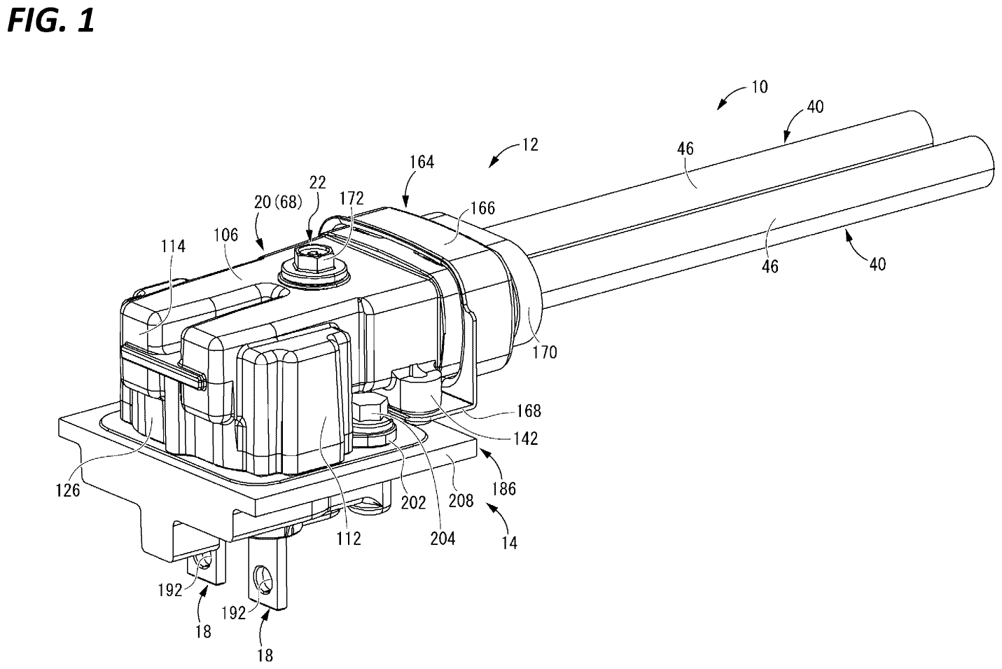

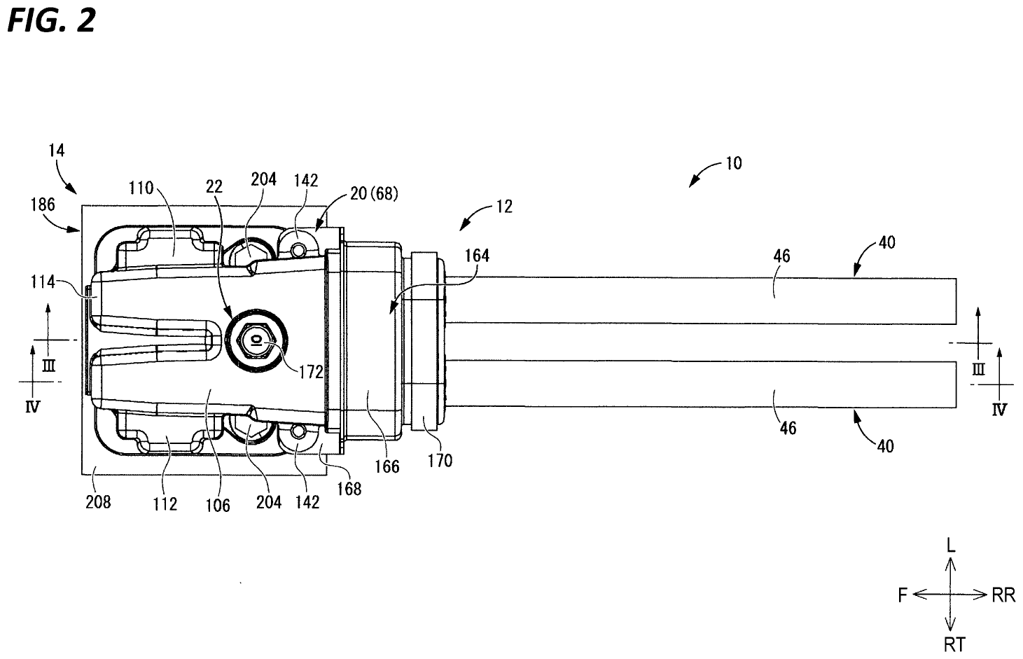

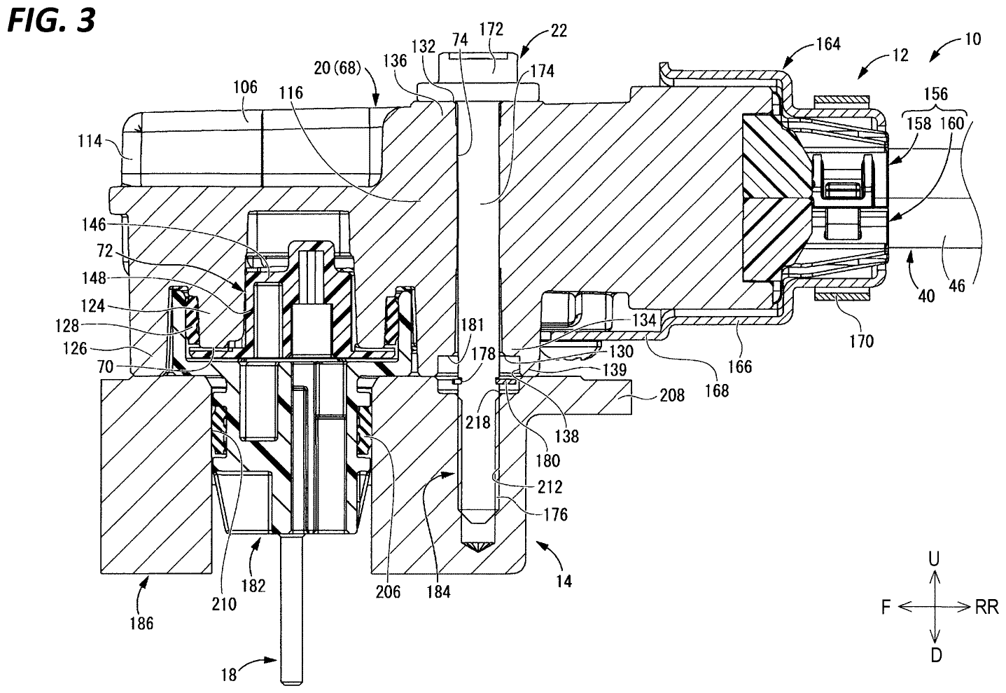

A connector assembly 10 of a first embodiment of the present disclosure is described below using FIGS. 1 to 11. The connector assembly 10 includes a first connector 12 and a second connector 14 to be detachably connected to the first connector 12. By connecting the first and second connectors 12, 14, first terminals 16 in the first connector 12 and second terminals 18 in the second connector 14 are connected to become electrically conductive. Note that the connector assembly 10 can be arranged in an arbitrary orientation. In the following description, upper and lower sides in FIG. 3 are referred to as upper and lower sides, left and right sides in FIG. 2 are referred to as front and rear sides, and upper and lower sides in FIG. 2 are referred to as left and right sides. Further, for a plurality of identical members, only some members may be denoted by a reference sign and the other members may not be denoted by the reference sign.

### (First Connector 12)

As also shown in FIGS. 3 to 5, the first connector 12 is provided with the first terminals 16 to be connected to the second terminals 18 provided in the second connector 14, a first housing 20 for accommodating and holding the first terminals 16 and a fastening bolt 22 to be fastened to a later-described nut 184 provided in the second connector 14. In the first embodiment, a pair of coated wires 40 are provided as described later, and the first terminal 16 is fixed to an end of each coated wire 40. That is, the first connector 12 is provided with a pair of the first terminals 16, 16 and the respective first terminals 16 are arranged apart from each other in a lateral direction.

### (First Terminal 16)

In the first embodiment, the second terminal 18 is a pin terminal. The specific structure of the first terminal 16 is not limited if the first terminal 16 includes a tubular connecting portion 24, into which a later-described columnar connecting portion 188 of the second terminal 18 is press-fit. However, the structure of a female terminal (10), for example, described in Japanese Unexamined Patent Publication No. 2021-028899 can be adopted. More particularly, the first terminal 16 of the first embodiment includes a first terminal body 26 and a clip spring 28 serving as a resilient member to be attached to a tip part (front end part) of the first terminal body 26.

### (First Terminal Body 26)

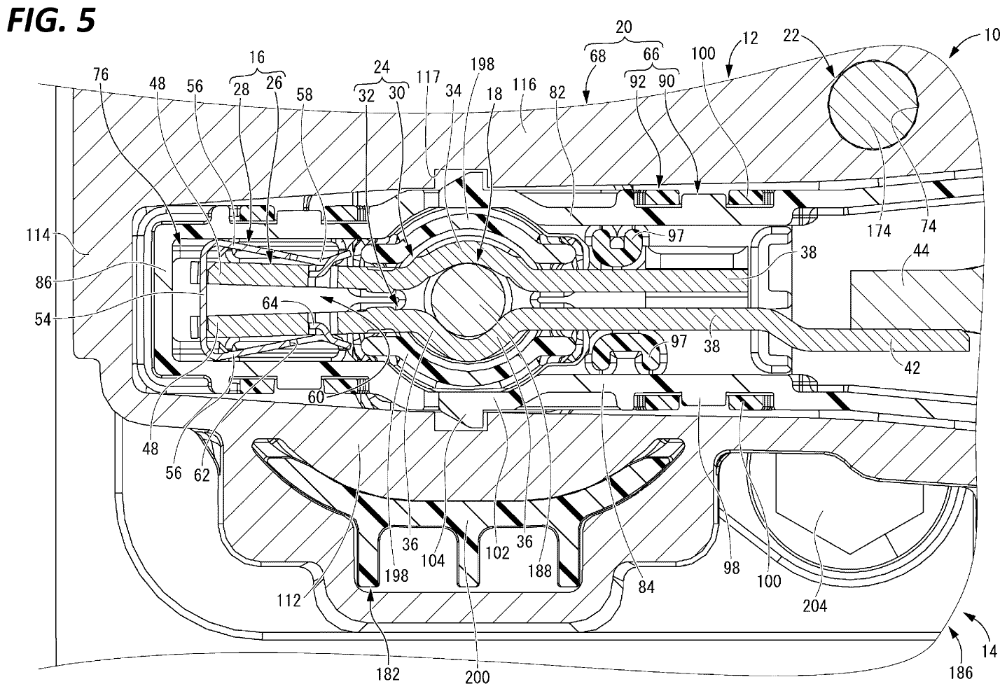

The first terminal body 26 is formed into a predetermined shape, such as by press-working a substantially strip-like metal flat plat as a whole. The first terminal body 26 includes the aforementioned tubular connecting portion 24 and, in the first embodiment, the tubular connecting portion 24 having a substantially hollow cylindrical shape is open toward both sides in a vertical direction. As also shown in FIG. 5, this tubular connecting portion 24 is composed of a first peripheral wall portion 30 located on a left side and a second peripheral wall portion 32 located on a right side, both having a substantially hollow half cylindrical shape. These first and second peripheral wall portions 30, 32 are facing each other in the lateral direction.

An arcuate protrusion 34 projecting radially inward in a circumferential central part while extending in a circumferential direction is provided on the inner peripheral surface of the first peripheral wall portion 30. Further, linear contact portions 36 projecting radially inward while extending in an axial direction (vertical direction) of the tubular connecting portion 24 are provided at a plurality of positions (two positions) separated in the circumferential direction on the inner peripheral surface of the second peripheral wall 32. In this way, as also shown in FIG. 5, when the columnar connecting portion 188 to be described later is press-fit into the tubular connecting portion 24, the outer peripheral surface of the columnar connecting portion 188 and the inner peripheral surface of the tubular connecting portion 24 come into contact at three positions on a circumference at the circumferential central part of the arcuate protrusion 34 and a pair of the linear contact portions 36, 36.

Further, a pair of base end side plate portions 38, 38 projecting rearward are provided on rear end parts of the first and second peripheral wall portions 30, 32, and are facing each other in the lateral direction. These base end side plate portions 38 are coupled to each other, such as by being bent in rear end parts thereof. Further, the first terminal body 26 includes a part extending further rearward than the respective base end side plate portions 38, and this rearward extending part serves as a wire fixing portion 42, to which the coated wire 40 is fixed. That is, the coated wire 40 is composed of a core wire 44 and an insulation coating 46 made of synthetic resin and covering the core wire 44 substantially over an entire length. The insulation coating 46 is stripped at the end of the coated wire 40 to expose the core wire 44 and the exposed core wire 44 is fixed to the wire fixing portion 42 of the first terminal body 26, whereby the first terminal body 26 and the coated wire 40 are connected. Note that a method for fixing the wire fixing portion 42 and the core wire 44 is not limited, and the wire fixing portion 42 and the core wire 44 may be fixed by adhesion, welding, crimping using a crimping piece or the like.

Further, a pair of tip side plate portions 48, 48 respectively projecting forward are provided on front end parts of the first and second peripheral wall portions 30, 32, and are facing each other in the lateral direction. That is, in the first terminal body 26, the respective base end side plate portions 38 are coupled to each other behind the first and second peripheral wall portions 30, 32, and the respective tip side plate portions 48 are cantilevered while being separated from each other and constitute free ends in front of the first and second peripheral wall portions 30, 32. In this way, the respective tip side plate portions 48 are resiliently deformable in directions toward or away from each other.

A substantially rectangular through hole 50 penetrating in a plate thickness direction (lateral direction) is formed in a central part in a width direction (vertical direction) in an intermediate part in the front-rear direction of each tip side plate portion 48. Further, a stopper portion 52 projecting laterally inward is provided in a widthwise central part on the laterally inner surface of each tip side plate portion 48. In the first embodiment, each stopper portion 52 is provided behind the through hole 50. In this way, the respective stopper portions 52 contact each other when the clip spring 28 is attached to the tip part of the first terminal body 26, whereby deformation amounts of the respective tip side plate portions 48 in the directions toward each other are limited and, consequently, the first and second peripheral wall portions 30, 32 connected behind the respective tip side plate portions 48 are prevented from coming too close to each other to excessively reduce an inner diameter of the tubular connecting portion 24.

### (Clip Spring 28)

The clip spring 28 biases the respective tip side plate portions 48 in the directions toward each other and applies biasing forces in the directions toward each other to the first and second peripheral wall portions 30, 32 connected behind the respective tip side plate portions 48 by being attached to the tip part of the first terminal body 26. As shown in FIG. 5, the clip spring 28 includes a substantially plate-like coupling plate 54 and a pair of pressing pieces 56, 56 projecting rearward from both lateral end parts of the coupling plate 54 and inclined to the directions toward each other. Bent parts 58 are provided in intermediate parts in the front-rear direction of the respective pressing pieces 56 and projecting tip parts of the respective pressing pieces 56 extend in directions separating from each other from the respective bent parts 58. Therefore, a facing distance of the respective pressing pieces 56 is shortest in a part where the respective bent parts 58 are formed, and a gap between these bent parts 58 serves as an insertion opening 60, through which the first terminal body 26 is inserted into the clip spring 28.

A substantially rectangular through window 62 penetrating through the pressing piece 56 in a plate thickness direction is formed in a central part in the width direction (vertical direction) in the bent part 58 of each pressing piece 56. A locking piece 64 projecting forward is provided in a widthwise center of a rear inner peripheral edge part of each through window 62. The respective locking pieces 64 are facing each other in the lateral direction and project more inward in the facing direction toward the front. These locking pieces 64 are resiliently deformable in the plate thickness direction, and the tip part of the first terminal body 26 is inserted into the insertion opening 60 of the clip spring 28 when the clip spring 28 is attached to the first terminal body 26 as described later. Then, by sliding the clip spring 28 rearward with respect to the first terminal body 26, the respective locking pieces 64 enter and are locked in the through windows 50 in the respective tip side plate portions 48 and the clip spring 28 is fixed to the first terminal body 26.

### (First Housing 20)

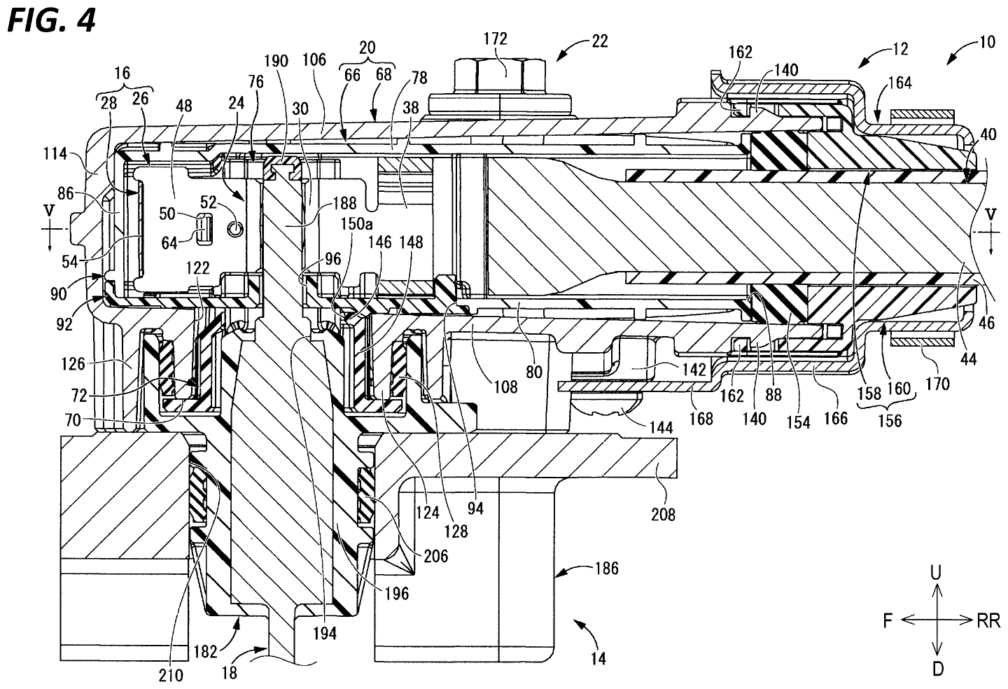

As also shown in FIGS. 4 and 5, the first housing 20 includes first connector housings 66 made of insulating synthetic resin and a shield shell 68 made of metal and to be fixedly assembled with the first connector housings 66 while covering the first connector housings 66. Further, a lower opening 70 open downward is provided in a front part of the shield shell 68, and a front retainer 72 made of synthetic resin is mounted in this lower opening 70. Further, as also shown in FIG. 3, the first housing 20 includes a bolt insertion hole 74 penetrating through the first housing 20 in the vertical direction, which is a connection direction of the first connector 12 to the second connector 14. In this embodiment, the bolt insertion hole 74 is provided in the shield shell 68.

### (First Connector Housings 66)

As also shown in FIGS. 4 and 5, the first connector housing 66 includes a terminal accommodating portion 76 substantially in the form of a rectangular tube for accommodating a front end part of the coated wire 40 and the first terminal 16 fixed to the end of the coated wire 40. In the first embodiment, since a pair of the coated wires 40 and a pair of the first terminals 16 are provided, a pair of the first connector housings 66, 66 are provided, and each first connector housing 66 includes the terminal accommodating portion 76. The respective first connector housings 66 (respective terminal accommodating portions 76) are separated from each other in the lateral direction and respectively extend in the front-rear direction. That is, the first connector housing 66 is provided with an upper wall portion 78 constituting a wall portion on an upper side of the terminal accommodating portion 76, a lower wall portion 80 constituting a wall portion on a lower side, a left wall portion 82 constituting a wall portion on a left side and a right wall portion 84 constituting a wall portion on a right side. A front part of each terminal accommodating portion 76 is closed by a front wall portion 86, and the coated wire 40 accommodated in each terminal accommodating portion 76 is pulled out to an outside space through a rear opening of each terminal accommodating portion 76. Therefore, a wire pull-out opening 88, through which each coated wire 40 is pulled out, is constituted by the rear opening of each terminal accommodating portion 76 in the first connector housing 66.

In the first embodiment, as also shown in FIG. 4, the first connector housing 66 is composed of a first connector housing body 90 and a first connector housing lid portion 92 to be assembled with the first connector housing body 90. That is, a lower window portion 94 open downward is provided in a front part of the lower wall portion 80 in the first connector housing body 90, and the first connector housing lid portion 92 is assembled to cover this lower window portion 94. In short, a part of the lower wall portion 80 in the first connector housing 66 is constituted by the first connector housing lid portion 92.

The first connector housing lid portion 92 is formed with an insertion hole 96, into which the columnar connecting portion 188 is inserted, at a position corresponding to the tubular connecting portion 24, i.e. the later-described columnar connecting portion 188 of the second terminal 18. Further, unillustrated insertion holes, into which later-described curved plate portions 198 located on both lateral sides of the columnar connecting portion 188 in the second connector 14 are inserted, are formed on both lateral sides of the insertion hole 96 in the first connector housing lid portion 92. Note that the first connector housing lid portion 92 is provided with a pair of supporting protrusions 97, 97 projecting upward and separated from each other in the lateral direction. As shown in FIG. 5, when the first connector 12 is assembled, the respective base end side plate portions 38 of the respective first terminal bodies 26 are inserted and supported between the pair of supporting protrusions 97, 97 in the lateral direction.

A method for fixing these first connector housing body 90 and first connector housing lid portion 92 is not limited, but the first connector housing body 90 and the first connector housing lid portion 92 are fixed by a locking mechanism in the first embodiment. That is, the left and right wall portions 82, 84 in the first connector housing body 90 are provided with lock protrusions 98 projecting laterally outward, and lock frame bodies 100 projecting upward are provided on both lateral sides of the first connector housing lid portion 92. By engaging the respective lock protrusions 98 with the respective lock frame bodies 100, the lower window portion 94 in the first connector housing body 90 is covered by the first connector housing lid portion 92 and the first connector housing 66 is configured.

Resilient pieces 102 resiliently deformable in the lateral direction are provided in intermediate parts in a length direction (front-rear direction) of the left and right wall portions 82, 84 of the first connector housing 66, and each resilient piece 102 is provided with a locking claw 104 projecting laterally outward. Further, locking recesses 117 to be described later are provided in the inner surface of the shield shell 68, and the first connector housing 66 is fixed to the shield shell 68 by locking the respective locking claws 104 to the respective locking recesses 117.

### (Shield Shell 68)

The shield shell 68 is shaped to substantially entirely cover the pair of first connector housings 66, 66. That is, the shield shell 68 is provided with an upper wall portion 106 for covering the respective first connector housings 66 from above, a lower wall portion 108 for covering the respective first connector housings 66 from below, a left wall portion 110 for covering the left first connector housing 66 from left, a right wall portion 112 for covering the right first connector housing 66 from right and a front wall portion 114 for covering the respective first connector housings 66 from front. Further, a partitioning portion 116 provided between the respective first connector housings 66 (respective terminal accommodating portions 76) in the lateral direction and partitioning an internal space of the shield shell 68 in the lateral direction is provided inside the shield shell 68. Further, as shown in FIG. 5, the locking recesses 117 engageable with the respective locking claws 104 of the first connector housings 66 are formed in the inner surfaces of the left wall portion 110, the right wall portion 112 and the partitioning portion 116 in the shield shell 68.

Further, a through hole 122 penetrating through the lower wall portion 108 in a thickness direction (vertical direction) is formed in a front part of the lower wall portion 108 of the shield shell 68. This through hole 122 has a substantially elliptical shape with a dimension in the lateral direction larger than a dimension in the front-rear direction, and is provided over the respective first connector housings 66 separated from each other in the lateral direction. That is, the respective insertion holes 96, into which the columnar connecting portions 188 to be described later are inserted, and the respective unillustrated insertion holes, into which the respective curved plate portions 198 to be described later are inserted, in the respective first connector housings 66 communicate with the outside space below through the common through hole 122.

An inner tube portion 124 projecting downward is provided on a peripheral edge part of this through hole 122, and the lower opening 70, into which the front retainer 72 is mounted, is constituted by a lower end part of the inner tube portion 124. The tubular connecting portion 24 of the first terminal 16 accommodated in each terminal accommodating portion 76 is exposed to outside through the lower opening 70 in the shield shell 68. Further, an outer tube portion 126 projecting downward is provided on an outer peripheral side of the inner tube portion 124 in the lower wall portion 108. When the connector assembly 10 is assembled, a substantially entire region of the lower end of the outer tube portion 126 except a rear part contacts a casing 186 to be described later in the second connector 14. Note that a waterproof rubber 128 is externally fit and mounted on the inner tube portion 124 to prevent water intrusion between the shield shell 68 and a second housing 182 to be described later when the connector assembly 10 is assembled.

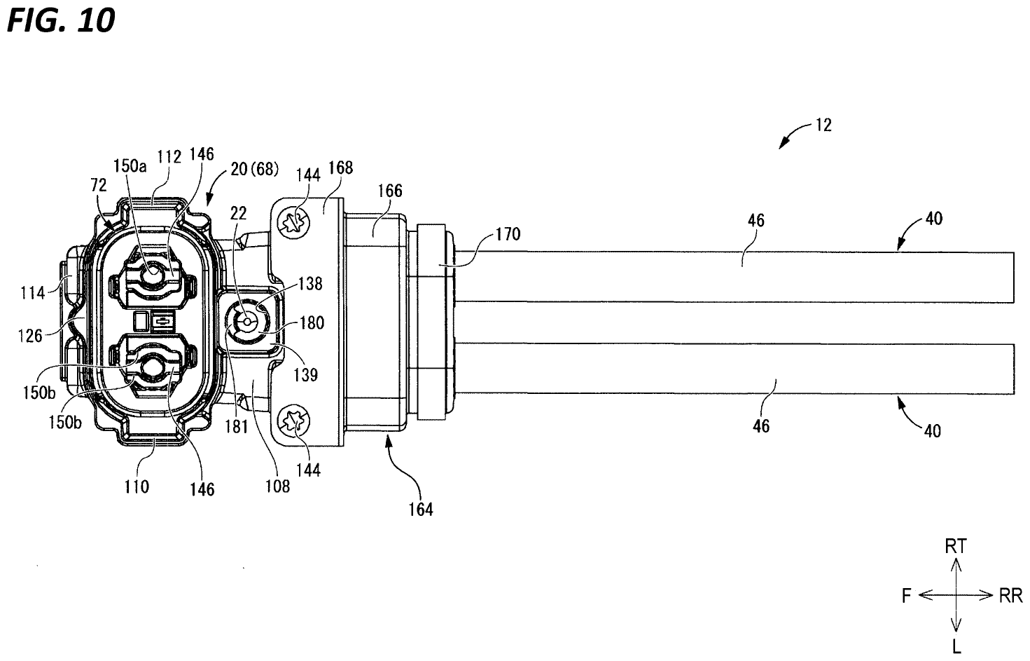

Here, the bolt insertion hole 74 penetrating in the vertical direction is provided behind a rear part of the outer tube portion 126 in the partitioning portion 116 of the shield shell 68. That is, the bolt insertion hole 74 includes a lower opening 130 serving as a front opening open downward to a front side in the connection direction of the first connector 12 to the second connector 14, and an upper opening 132 serving as a rear opening open upward toward a rear side in the connection direction. In the partitioning portion 116 of the shield shell 68, a peripheral edge part of the lower opening 130 is a lower peripheral edge part 134 serving as a front peripheral edge part, and a peripheral edge part of the upper opening 132 is an upper peripheral edge part 136 serving as a rear peripheral edge part. In the first embodiment, a substantially circular recess 138 open forward in the connection direction (downward) is formed in the lower peripheral edge part 134, and this recess 138 has a predetermined depth (dimension in the vertical direction). Particularly, in the shield shell 68, a contact portion 139 projecting downward is formed at the formation position of the bolt insertion hole 74 and, as shown in FIG. 10, has a substantially rectangular shape in a bottom view. In the first embodiment, the substantially circular recess 138 is formed in a substantially central part of the contact portion 139.

Further, in the shield shell 68, lock claw portions 140 projecting vertically outward are provided on rear end parts of the upper and lower wall portions 106, 108. These lock claw portions 140 are provided at positions corresponding to the respective first connector housings 66, and a pair of the lock claw portions 140, 140 are provided apart from each other in the lateral direction on the rear end parts of the upper and lower wall portions 106, 108. Further, fixing portions 142, to which a shield bracket 164 to be described later is fixed, are provided on both lateral sides of a rear end part of the shield shell 68. In the first embodiment, a front projecting portion 168 projecting forward from the shield bracket 164 is overlapped on the fixing portions 142, and the shield shell 68 and the shield bracket 164 are fixed to each other by bolts 144.

As also shown in FIGS. 3, 4 and the like, the front retainer 72 mounted into the lower opening 70 of such a shield shell 68 has a substantially bottomed tube shape and includes a substantially elliptical upper bottom wall portion 146 and a peripheral wall portion 148 projecting downward from an outer peripheral edge part of the upper bottom wall portion 146. As also shown in FIG. 10, through holes 150a, through which the respective columnar connecting portions 188 are inserted, are formed to penetrate in the vertical direction at positions corresponding to the respective tubular connecting portions 24 in the first connector 12, i.e. at positions corresponding to the later-described respective columnar connecting portions 188 in the second connector 14. Further, through holes 150b, through which the later-described respective curved plate portions 198 in the second connector 14 are inserted, are formed to penetrate in the vertical direction on both lateral sides of the respective through holes 150a. In this way, when the first and second connectors 12, 14 are connected, the respective columnar connecting portions 188 and the respective curved plate portions 198 are inserted into the respective terminal accommodating portions 76 in the first connector housings 66 through the respective through holes 150a, 150b in the upper bottom wall portion 146. This front retainer 72 is inserted into the inner tube portion 124 in the shield shell 68, and fixed by a locking mechanism provided on the outer peripheral surface of the peripheral wall portion 148 and the inner peripheral surface of the inner tube portion 124.

An annular waterproof rubber 154 is externally fit and mounted on each coated wire 40 pulled out rearward from the wire pull-out opening 88 of each first connector housing 66 as described above, and inserted into the rear opening in each first connector housing 66. Further, a back retainer 156 for preventing the detachment of the waterproof rubber 154 is provided behind the waterproof rubber 154 on each coated wire 40.

In the first embodiment, the back retainer 156 is composed of an upper retainer 158 and a lower retainer 160, which can be assembled with each other, and the upper and lower retainers 158, 160 are assembled to sandwich each coated wire 40 from both vertical sides in a rear part of the first connector housing 66. Each of these upper and lower retainers 158, 160 includes a pair of lock frame bodies 162, 162 projecting forward. In this way, the back retainer 156 configured by assembling the upper and lower retainers 158, 160 is fixed behind the waterproof rubber 154 by locking the respective lock claw portions 140 provided in the rear end part of the shield shell 68 and the respective lock frame bodies 162. Note that the upper and lower retainers 158, 160 may have the same shape and the back retainer 156 may be configured by assembling the upper and lower retainers 158, 160 vertically inverted from each other with each other.

This back retainer 156 is covered by the shield bracket 164 made of metal. The shield bracket 164 includes a tubular wall portion 166 and covers the back retainer 156 from an outer peripheral side. This tubular wall portion 166 includes the front projecting portion 168 projecting forward in a lower part, and the front projecting portion 168 is overlapped on the fixing portions 142 of the shield shell 68 and fixed by the bolts 144, whereby the shield bracket 164 and the shield shell 68 are fixed to each other. Note that an unillustrated substantially tubular shield member for covering the respective coated wires 40 extending out rearward may be externally fit to the tubular wall portion 166 of the shield bracket 164, and this shield member may be fixed to the tubular wall portion 166 by a crimp band 170.

### (Fastening Bolt 22)

The fastening bolt 22 includes a bolt head portion 172, an inserting shaft portion 174 projecting downward to the front side in the connection direction from the bolt head portion 172 and to be inserted into the bolt insertion hole 74, a bolt-side screw portion 176 projecting forward in the connection direction (downward) from the tip (lower end) of the inserting shaft portion 174 and an engaging protrusion located on a tip side of the inserting shaft portion 174 and projecting toward an outer peripheral side of the fastening bolt 22. In the first embodiment, an annular ring mounting groove 178 open toward the outer peripheral side is provided on the tip side of the inserting shaft portion 174, and a C-ring 180, which is a ring member made of metal, is mounted into this ring mounting groove 178, thereby configuring the engaging protrusion projecting toward the outer peripheral side. That is, the C-ring 180 constituting the engaging protrusion substantially annular projects with a predetermined width in a radial direction toward the outer peripheral side from the outer peripheral surface of the fastening bolt 22. In this way, when the C-ring 180 and a bottom surface 181 of the recess 138 contact each other as described later, a sufficient contact area is ensured. A vertical dimension of the ring mounting groove 178 and that of the C-ring 180 are substantially equal, and the C-ring 180 is non-displaceable in the vertical direction on the fastening bolt 22.

Note that, preferably, the ring member made of metal is, for example, cut in one place in the circumferential direction, and a C-ring or an E-ring are suitably used. In this way, the ring member such as a C-ring or an E-ring can be laterally fit into the ring mounting groove 178 in the inserting shaft portion 174 through a circumferential cut.

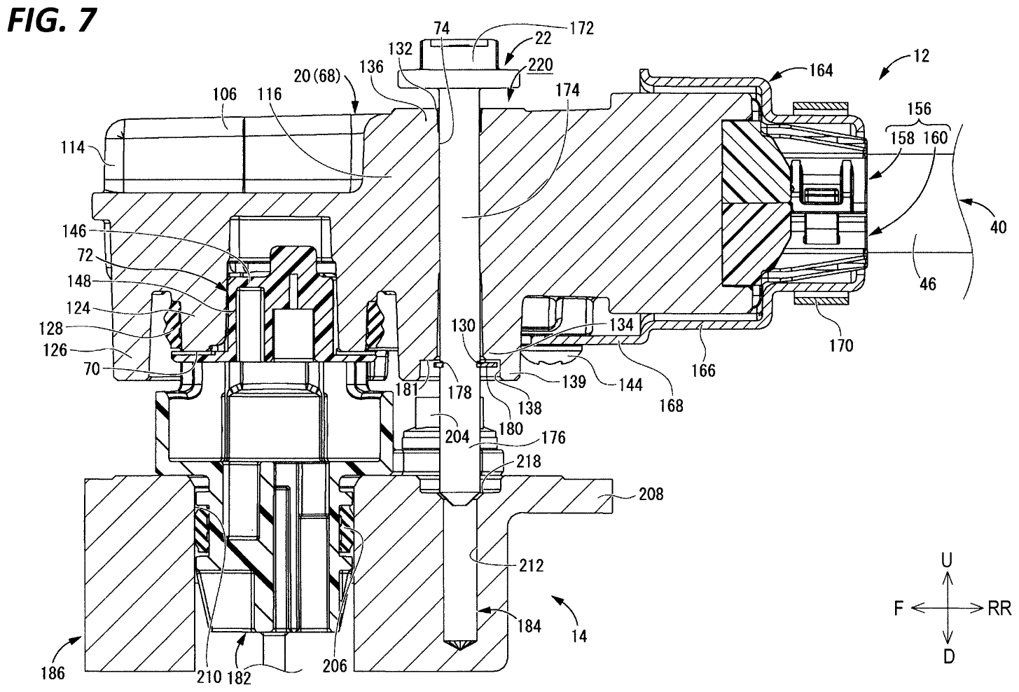

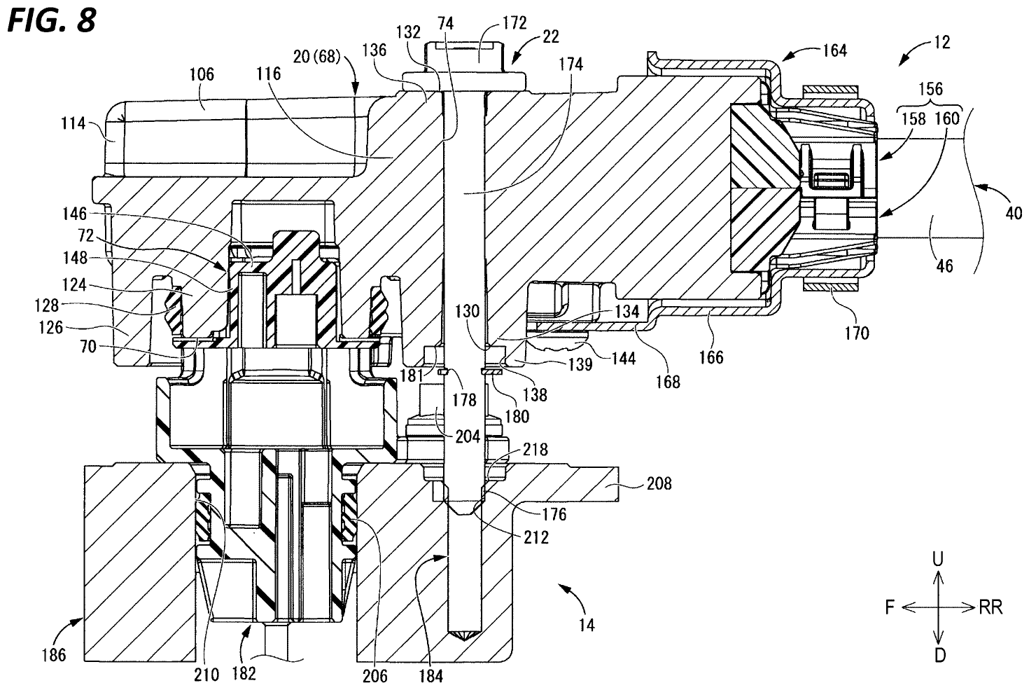

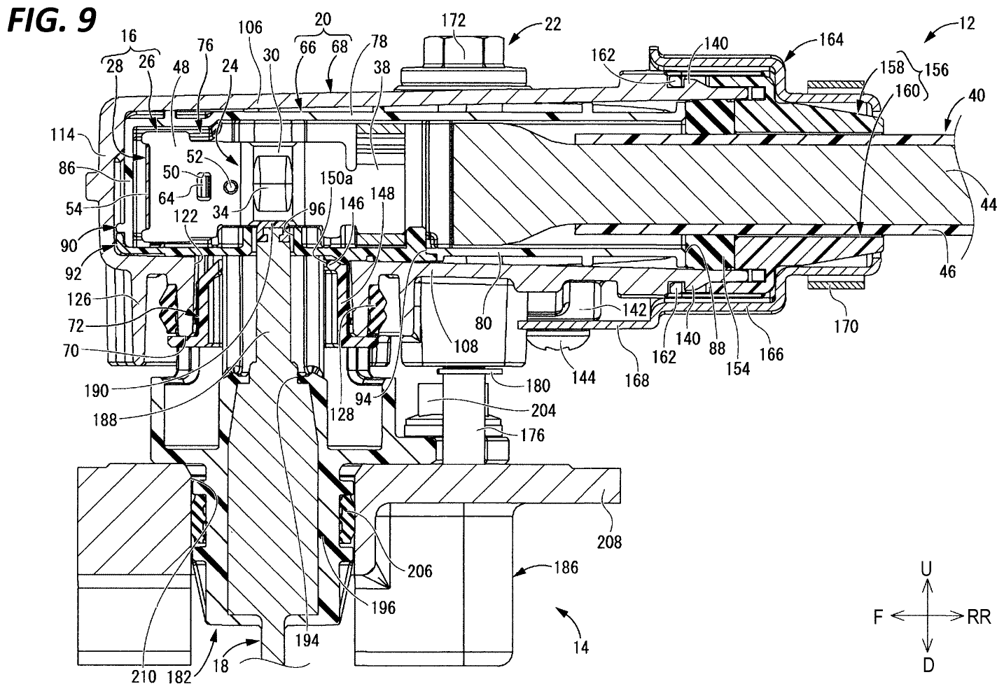

In this fastening bolt 22, a length (vertical dimension) from the lower end of the bolt head portion 172 to the upper end of the C-ring is longer than a length (vertical dimension) of the bolt insertion hole 74 penetrating through the shield shell 68 in the vertical direction. Further, a projecting dimension of the C-ring 180 toward the outer peripheral side from the outer peripheral surface of the fastening bolt 22 is smaller than a radial width of the bottom surface 181 in the recess 138. In this way, the fastening bolt 22 is displaceable by a predetermined dimension in the connection direction (vertical direction) with respect to the shield shell 68 from a position where the lower end of the bolt head portion 172 contacts the upper end of the bolt insertion hole 74, i.e. the upper peripheral edge part 136 (connection start position shown in FIGS. 8 and 9 to be described later) to a position where the upper end of the C-ring 180 contacts the lower end of the bolt insertion hole 74, i.e. the bottom surface 181 of the recess 138 provided in the lower peripheral edge part 134 (initial position shown in FIG. 7 to be described later), and is inseparable. Therefore, a depth of the recess 138 can be, for example, set to be substantially equal to a displaceable vertical dimension of the fastening bolt 22.

Further, a part of the fastening bolt 22 below the C-ring 180 is the bolt-side screw portion 176, but no screw portion is provided on a tipmost part of the fastening bolt 22. The bolt-side screw portion 176 is configured by forming an external thread on the outer peripheral surface of the fastening bolt 22 over a predetermined length in the vertical direction from a part separated upward from the tipmost of the fastening bolt 22 by a predetermined dimension.

### (Second Connector 14)

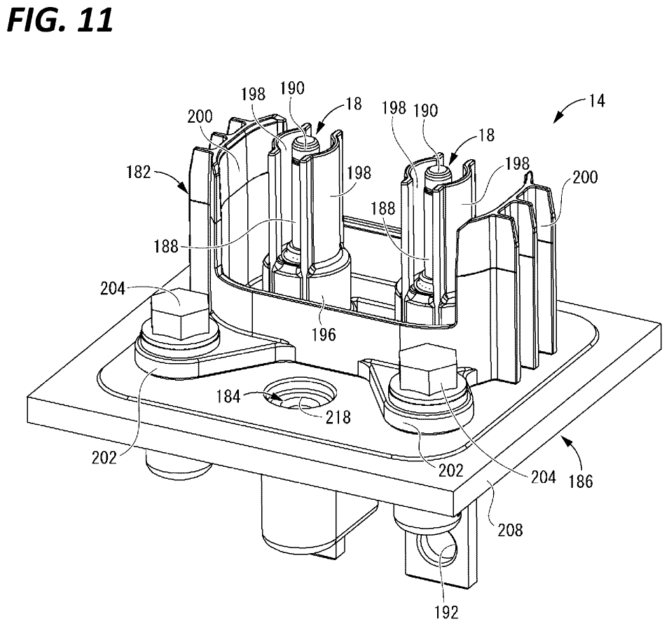

As also shown in FIG. 11, the second connector 14 includes the second terminals 18 to be connected to the first terminals 16, the second housing 182 for accommodating and holding the second terminals 18 and the nut 184 to be fastened to the fastening bolt 22. Since the pair of first terminals 16, 16 are provided in the first connector 12 in the first embodiment, the second connector 14 is provided with a pair of the second terminals 18, 18 and these second terminals 18 are arranged apart from each other in the lateral direction. Further, the second connector 14 is provided with the casing 186 made of metal, and the respective second terminals 18 are held to project upward in the second housing 182 fixed to the casing 186.

In the first embodiment, each second terminal 18 is a pin terminal and includes the columnar connecting portion 188. Further, in the columnar connecting portion 188 of each second terminal 18, a resin cap 190 is provided on a tip side in a press-fitting direction (direction from bottom to top) into the tubular connecting portion 24 of the first terminal 16. A bolt insertion hole 192 is provided in a base end part (lower end part) of each second terminal 18, and each second terminal 18 is fixed to a terminal portion of an unillustrated device or the like by a bolt inserted into each bolt insertion hole 192. Note that the bolt insertion hole 192 in each second terminal 18 may not be provided, and each second terminal may be fixed to the device or the like by crimping and fixing the base end of each second terminal to a wire of the unillustrated device or the like.

Each of these second terminals 18 is fixedly held in the second housing 182. As also shown in FIGS. 4 and 11, the second housing 182 includes substantially tubular peripheral wall portions 196 including through holes 194, through which the respective second terminals 18 are inserted, in upper end parts, and a pair of the peripheral wall portions 196, 196 are provided apart from each other in the lateral direction. Further, curved plate portions 198 having a predetermined length (vertical dimension) and projecting upward are provided on the upper end surface of each peripheral wall portion 196. A pair of the curved plate portions 198 are provided on each peripheral wall portion 196 and facing apart from each other in the lateral direction. Each curved plate portion 198 is curved along a circumferential direction of each peripheral wall portion 196 and has a predetermined circumferential dimension.

The second terminal 18 is inserted and arranged in each peripheral wall portion 196, and the second housing 182 and each second terminal 18 are fixed with each columnar connecting portion 188 projecting upward through the through hole 194. Note that a method for fixing the second housing 182 and each second terminal 18 is not limited, and the second housing 182 and each second terminal 18 may be fixed by press-fitting, concave-convex locking, adhesion, welding or the like. In the first embodiment, the second housing 182 provided with each second terminal 18 is formed as an integrally molded product by being molded with each second terminal 18 inserted in a molding cavity during the molding of the second housing 182. With each second terminal 18 fixed to the second housing 182, the columnar connecting portion 188 is located on an inner peripheral side of each curved plate portion 198 while being separated by a predetermined radial distance and the columnar connecting portion 188 is covered over an entire length in the length direction by each curved plate portion 198.

Further, the second housing 182 is integrally provided with a pair of outer wall portions 200, 200 located laterally outward of the respective peripheral wall portions 196 and projecting upward. This pair of outer wall portions 200, 200 are located laterally outward of the outer ones of the pairs of curved plate portions 198, 198 while being separated by a predetermined separation distance. Further, as also shown in FIG. 11, the second housing 182 is integrally provided with a pair of leg portions 202, 202 projecting rearward, and the second housing 182 having each second terminal 18 fixed thereto is fixed to the casing 186 by bolts 204 inserted through the leg portions 202. With the second housing 182 fixed to the casing 186, the columnar connecting portion 188 of each second terminal 18 projects upward from the peripheral wall portion 196 and is exposed to an outside space. Further, an annular waterproof rubber 206 is externally fit and mounted on a part of the outer peripheral surface of the second housing 182 to be inserted into a later-described insertion hole 210 in the casing 186.

The casing 186 is provided with a rectangular plate portion 208 having a rectangular shape in a plan view, and the insertion hole 210, into which the second housing 182 is inserted, is formed in a front part of the rectangular plate portion 208. Further, the aforementioned nut 184 is provided over a predetermined vertical dimension in a lateral center of a part behind the insertion hole 210 in the rectangular plate portion 208. That is, a nut-side screw portion 212 constituted by an internal thread is formed with a predetermined vertical dimension on the inner peripheral surface of the nut 184.

### (Assembly of Connector Assembly 10)

Hereinafter, a specific example of a method for assembling the connector assembly 10 by connecting the first connector 12 and the second connector 14 is described. Note that the assembly method of the connector assembly 10 is not limited to the one described below.

First, the core wire 44 exposed by stripping the insulation coating 46 in the end of each coated wire 40 is fixed to the wire fixing portion 42 of each first terminal body 26, and the clip spring 28 is attached to the front end part of each first terminal body 26. In this way, each first terminal 16 is fixed to the end of the coated wire 40. The waterproof rubber 154 is externally fit to each coated wire 40, and each back retainer 156 is configured by assembling the upper and lower retainers 158, 160 from both vertical sides to sandwich each coated wire 40 behind the waterproof rubber 154.

Subsequently, each coated wire 40 assembled with the first terminal 16, the waterproof rubber 154 and the back retainer 156 are inserted through the rear opening of the first connector housing body 90. After each first terminal 16 is inserted to a predetermined position, the first connector housing lid portion 92 is assembled with the first connector housing body 90, whereby each first terminal 16 is fixed at a predetermined position in the terminal accommodating portion 76 in each first connector housing 66. Each first connector housing 66 having the first terminal 16 assembled therewith is inserted through the rear opening of the shield shell 68 and the respective locking claws 104 in each first connector housing 66 are locked to the respective locking recesses 117 in the shield shell 68. In this way, the first connector housing 66 is fixed to the shield shell 68. Further, the front retainer 72 is mounted into the lower opening 70 of the shield shell 68 from below. In this way, the first housing 20 is configured.

Subsequently, the respective lock frame bodies 162 of each back retainer 156 are locked and fit to the respective lock claw portions 140 in the rear end part of the shield shell 68. Thereafter, each coated wire 40 is inserted into the tubular wall portion 166 of the shield bracket 164 and the fixing portions 142 of the shield shell 68 and the front projecting portion 168 of the shield bracket 164 are overlapped and fixed by the bolts 144. Note that the shield member for covering each coated wire 40 may be fixed to the tubular wall portion 166 of the shield bracket 164 at a suitable timing by the crimp band 170.

Further, the fastening bolt 22 is inserted into the bolt insertion hole 74 in the shield shell 68 from above. In this way, a lower part of the fastening bolt 22 projects downward from the shield shell 68, and the C-ring 180 is laterally (from a direction orthogonal to the vertical direction) mounted into the ring mounting groove 178 on the fastening bolt 22. In this way, the first connector 12 is completed. In the completed first connector 12, the unillustrated shield member for covering each coated wire 40, the shield bracket 164 and the shield shell 68 are electrically connected.

Subsequently, the second housing 182 is formed as an integrally molded product provided with each second terminal 18, and the waterproof rubber 206 is mounted on the outer peripheral surface of this second housing 182. Then, the lower part of the second housing 182 having the waterproof rubber 206 mounted thereon is inserted into the insertion hole 210 in the casing 186, and the second housing 182 is fixed to the casing 186 by the respective bolts 204. In this way, the second connector 14 is completed.

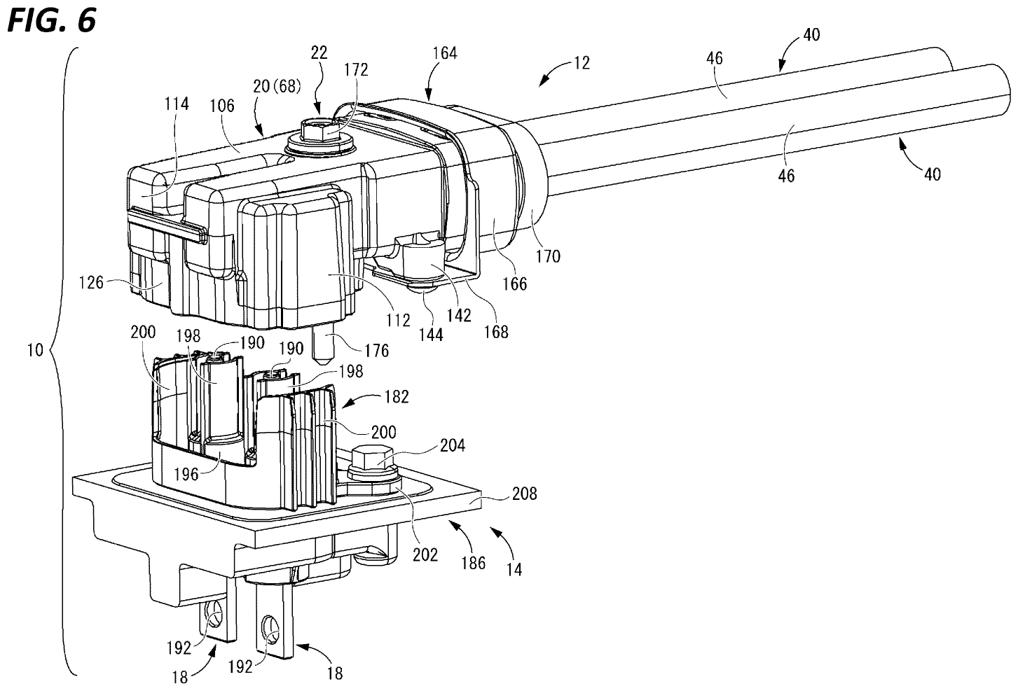

Then, the completed first and second connectors 12, 14 are caused to face each other in the vertical direction as shown in FIG. 6. Thereafter, the first and second connectors 12, 14 are brought closer to each other. In this way, the columnar connecting portions 188 of the respective second terminals 18 in the second connector 14 are inserted into the respective through holes 150a in the front retainer 72 of the first connector 12 and the respective curved plate portions 198 are inserted into the respective through holes 150b in the front retainer 72. Note that, at this point of time, the columnar connecting portion 188 of each second terminal 18 is slightly separated from or not at all in contact with the lower opening of the tubular connecting portion 24 of each first terminal 16, and no contact pressure is generated between each first terminal 16 and each second terminal 18. In this state, the first connector 12 is temporarily fixed to the second connector 14.

With the first and second connectors 12, 14 temporarily fixed, the tip (lower end) of the fastening bolt 22 projecting downward from the first connector 12 is in contact with an upper opening 218 of the nut 184 of the second connector 14 as shown in FIG. 7. Since the fastening bolt 22 is displaceable in the vertical direction by the predetermined distance with respect to the shield shell 68, the fastening bolt 22 is displaced upward as contacting the upper opening 218 of the nut 184. An upward displacement of the fastening bolt 22 is limited by the contact of the upper end of the C-ring 180 and the bottom surface 181 of the recess 138 provided in the lower surface of the shield shell 68. In short, as shown in FIG. 7, with the fastening bolt 22 located at the initial position, the fastening bolt 22 is displaced upward with respect to the shield shell 68 until the upper end of the C-ring 180 contacts the bottom surface 181 of the recess 138, and a gap 220 is formed in the vertical direction between the lower end of the bolt head portion 172 and the upper surface of the shield shell 68. In other words, at the initial position, the fastening bolt 22 is restricted from being displaced rearward in the connection direction (upward) by the engagement of the engaging protrusion (C-ring 180) with the front peripheral edge part in the connection direction (lower peripheral edge part 134) configured to include the bottom surface 181 of the recess 138.

By fastening the fastening bolt 22 by a predetermined distance from a state shown in FIG. 7 where the fastening bolt 22 is at the initial position, the bolt-side screw portion 176 and the nut-side screw portion 212 are threadably engaged. Specifically, as shown in FIGS. 8 and 9, the bolt-side screw portion 176 and the nut-side screw portion 212 are threadably engaged until the lower end of the bolt head portion 172 and the upper peripheral edge part 136 on the upper surface of the shield shell 68 come into contact with each other, and the fastening bolt 22 is fed and displaced downward. In this way, as shown in FIG. 8, the bolt-side screw portion 176 and the nut-side screw portion 212 are threadably engaged by a predetermined dimension. As a result, the C-ring 180 is displaced toward the opening side (lower side) from the bottom surface 181 of the recess 138 and the gap 220 between the lower end of the bolt head portion 172 and the upper surface of the shield shell 68 disappears. In a state shown in FIGS. 8 and 9, the fastening bolt 22 is at a connection start position. In other words, at the connection start position, the fastening bolt 22 is restricted from being displaced forward in the connection direction (downward) by the engagement of the bolt head portion 172 with the rear peripheral edge part in the connection direction (upper peripheral edge part 136). Also in this state where the fastening bolt 22 is at the connection start position, relative positions of the first and second connectors 12, 14 do not change, wherefore no contact pressure is generated between each first terminal 16 and each second terminal 18.

Note that a screwing distance in the vertical direction of the bolt-side screw portion 176 and the nut-side screw portion 212 is not limited with the fastening bolt 22 located at the connection start position, but the bolt-side screw portion 176 and the nut-side screw portion 212 are preferably threadably engaged by about three screw threads. That is, the fastening bolt 22 is preferably displaced by about three screw threads in the vertical direction from the initial position of the fastening bolt 22 shown in FIG. 7 to the connection start position thereof shown in FIGS. 8 and 9, and the depth (vertical dimension) of the recess 138 and the vertical dimension of the gap 220 are also preferably nearly equal to this displacement.

By fastening the fastening bolt 22 from the state shown in FIGS. 8 and 9 where the fastening bolt 22 is at the connection start position, the fastening bolt 22 is fed downward and, accordingly, the first and second connectors 12, 14 are brought closer to each other. In this way, the press-fitting of each columnar connecting portion 188 of the second connector 14 into each tubular connecting portion 24 of the first connector 12 is started. That is, the press-fitting of each columnar connecting portion 188 into each tubular connecting portion 24 is preferably started with about three screw threads of the bolt-side screw portion 176 and those of the nut-side screw portion 212 threadably engaged. By further fastening the fastening bolt 22 and further threadably engaging the bolt-side screw portion 176 and the nut-side screw portion 212, the press-fitting of each columnar connecting portion 188 into each tubular connecting portion 24 is completed as shown in FIGS. 1 to 5. In a state shown in FIGS. 1 to 5, the fastening bolt 22 is arranged at a connection completion position and the first connector 12 is completely fixed to the first connector 14. In this way, the connection of the first and second connectors 12, 14 is completed and the connector assembly 10 is completed.

The fastening of the fastening bolt 22, i.e. the threadable engagement of the bolt-side screw portion 176 and the nut-side screw portion 212, is preferably performed, for example, until the lower end of the outer tube portion 126 of the shield shell 68 and the lower end of the contact portion 139 come into contact with the upper surface of the casing 186 in the second connector 14. In this way, the shield shell 68 and the casing 186 can be brought into an electrically conductive state, and a shielding effect can be exhibited in the unillustrated shield member covering each coated wire 40 by way of the shield shell 68 and the shield bracket 164 from the casing 186 by grounding the casing 186. Note that the shielding effect may not be exhibited in the connector assembly according to the present disclosure, and the fastening of the fastening bolt 22 may be finished when the fastening bolt 22 is displaced downward by a predetermined distance, i.e. when each columnar connecting portion 188 is press-fit into each tubular connecting portion 24 to a certain extent.

In the connector assembly 10 of the first embodiment structured as described above, the bolt-side screw portion 176 and the nut-side screw portion 212 are threadably engaged over the predetermined distance in advance when the press-fitting of each columnar connecting portion 188 into each tubular connecting portion 24 is started. In this way, the breakage of the screw threads in the bolt-side screw portion 176 and the nut-side screw portion 212 is avoided and durability is improved as compared to a configuration in which the threadable engagement of the bolt-side screw portion 176 and the nut-side screw portion 212 is started when the press-fitting of each columnar connecting portion 188 into each tubular connecting portion 24 requiring a large force is started. Particularly, such a configuration in which the bolt-side screw portion 176 and the nut-side screw portion 212 are already threadably engaged when the press-fitting of each columnar connecting portion 188 into each tubular connecting portion 24 is started can be realized without making the fastening bolt 22 longer, the interference of the fastening bolt 22 with another member or the casing 186, the second housing 182 or the like in the second connector 14 is avoided when the first and second connectors 12, 14 are connected, and assemblability is improved.

Further, when the fastening bolt 22 is displaced from the initial position to the connection start position, the respective columnar connecting portions 188 and the respective curved plate portions 198 in the second connector 14 are inserted into the respective through holes 150a, 150b in the first connector 12 and the first connector 12 is temporarily fixed to the second connector 14. Therefore, deviations of the first and second connectors 12, 14 in a horizontal direction (front-rear direction or lateral direction) and the like are suppressed when the fastening bolt 22 is fastened and displaced from the initial position to the connection start position, and assemblability is further improved.

The first housing 20 includes the first connector housings 66 and the shield shell 68, and the shield shell 68 is provided with the bolt insertion hole 74, into which the fastening bolt 22 is inserted. In this way, it is, for example, possible not only to configure a shield path, utilizing the shield shell 68 and the casing 186, but also to apply a fastening force of the fastening bolt 22 to the shield shell 68 and the casing 186, which are both member made of metal, wherefore durability is improved, for example, as compared to the case where a bolt insertion hole is provided in a member made of synthetic resin.

The fastening bolt 22 is arranged at the initial position by the contact of the engaging protrusion (C-ring 180) with the bottom surface 181 of the recess 138, and arranged at the connection start position by the contact of the bolt head portion 172 with the upper peripheral edge part 136. In this way, by properly setting the depth (vertical dimension) of the recess 138, it is possible to adjust the size of the gap 220 when the fastening bolt 22 is at the initial position and, consequently, the screwed amount of the bolt-side screw portion 176 and the nut-side screw portion 212 when the fastening bolt 22 is at the connection start position. Further, the fastening bolt 22 can be more reliably displaced upward and arranged at the initial position by the contact of the bottom surface 181 of the recess 138 and the C-ring 180. In addition, the fastening force of the fastening bolt 22 can be reliably exerted as a force for bringing the first and second connectors 12, 14 closer to each other, i.e. a press-fitting force of each columnar connecting portion 118 into each tubular connecting portion 24 by bringing the bolt head portion 172 into contact with the upper peripheral edge part 136.

By arranging the fastening bolt 22 at the connection completion position, the first connector 12 is completely fixed to the second connector 14. That is, by fastening the fastening bolt 22, the press-fitting of each columnar connecting portion 188 into each tubular connecting portion 24 can be completed and a press-fitting operation requiring a relatively large force can be accomplished by bolt fastening.

### Second Embodiment

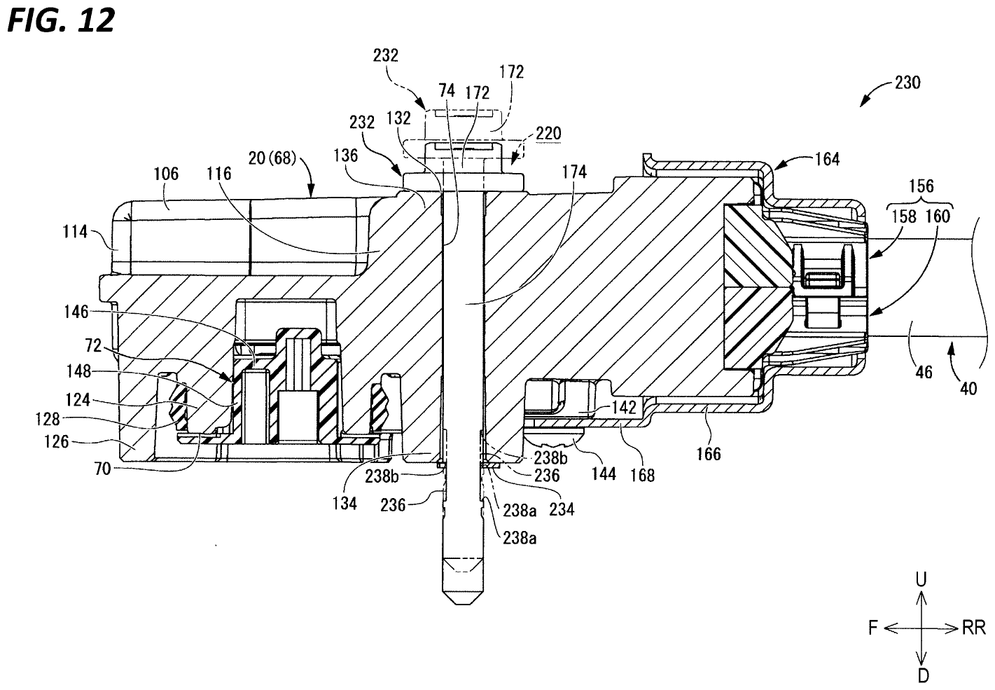

Next, a first connector 230 constituting a connector assembly of a second embodiment of the present disclosure is described using FIG. 12. The first connector 230 of the second embodiment is basically structured similarly to the first connector 12 of the first embodiment. However, the C-ring 180 is mounted on the fastening bolt 22 substantially non-displaceably in the vertical direction in the first connector 12 of the first embodiment, whereas a C-ring 234, which is a ring member made of metal constituting an engaging protrusion, is mounted displaceably in the vertical direction on a fastening bolt 232. Note that since a structure similar to that of the first embodiment can be adopted for a second connector 14 to be connected to the first connector 230 in the second embodiment, the second connector 14 is not shown. Further, points of difference from the first embodiment are described below, and substantially the same members and parts as those of the first embodiment are denoted by the same reference signs as in the first embodiment in FIG. 12 and are not described in detail. In FIG. 12, the fastening bolt 232 is shown by a solid line in a single state of the first connector 230 before connection to the second connector 14 or in a state at a connection start position, and the fastening bolt 232 at an initial position is shown by a two-dot chain line.

That is, an annular ring mounting groove 236 open toward an outer peripheral side is provided on a tip side (lower end side) of an inserting shaft portion 174 of the fastening bolt 232, and this ring mounting groove 236 has a predetermined vertical dimension larger than that of the C-ring 234. In this way, the C-ring 234 is movable in the vertical direction from a lower end surface 238a on a front side in a connection direction (lower side) to an upper end surface 238b on a rear side in the connection direction (upper side) in the ring mounting groove 236. Note that, in the second embodiment, the C-ring 234 is fixed to a peripheral edge part (lower peripheral edge part 134) of a lower opening 130 of a bolt insertion hole 74.

In the first connector 230 thus structured, the fastening bolt 232 moves, for example, downward with gravity and is at the position shown by the solid line in FIG. 12 in the single state before connection to the second connector 14. That is, the lower end surface of a bolt head portion 172 and the upper surface (upper peripheral edge part 136) of a shield shell 68 are in contact and the C-ring 234 and the upper end surface 238b of the ring mounting groove 236 are in contact.

In the case of connecting the first and second connectors 230, 14 from this state, the first and second connectors 230, 14 are caused to face each other in the vertical direction as in FIG. 6 described above and brought closer to each other. In this way, the tip of the fastening bolt 232 (tip of a bolt-side screw portion 176) contacts an upper opening 218 of a nut 184 in the second connector 14 and the fastening bolt 232 is displaced upward to the initial position as shown by the two-dot chain line in FIG. 12. As a result, a gap 220 is formed in the vertical direction between the lower end surface of the bolt head portion 172 and the upper surface (upper peripheral edge part 136) of the shield shell 68, and the C-ring 234 and the lower end surface 238a of the ring mounting groove 236 contact each other. In other words, as shown by the two-dot chain line in FIG. 12, the C-ring 234 is locked to the front end surface (lower end surface 238a) in the connection direction of the ring mounting groove 236 with the fastening bolt 232 located at the initial position.

Thereafter, the bolt-side screw portion 176 of the fastening bolt 232 at the initial position and a nut-side screw portion 212 of the nut 184 are threadably engaged, and the fastening bolt 232 is fed downward. In this way, the fastening bolt 232 is displaced to the connection start position below the initial position as shown by the solid line in FIG. 12. In this state, the lower end surface of the bolt head portion 172 and the upper surface (upper peripheral edge part 136) of the shield shell 68 are in contact and the gap 220 has disappeared. Further, since the fastening bolt 232 is displaced downward with respect to the shield shell 68, the C-ring 234 moves toward the rear end surface (upper end surface 238b) in the connection direction in the ring mounting groove 236 and, for example, the C-ring 234 and the upper end surface 238b of the ring mounting groove 236 contact each other. After the fastening bolt 232 is arranged at the connection start position, the first and second connectors 230, 14 are displaced in directions toward each other, each columnar connecting portion 188 in the second connector 14 is press-fit into each tubular connecting portion 24 in the first connector 230 and the connector assembly is completed by fastening the fastening bolt 232 as in the first embodiment.

Also in the first connector 230 of the second embodiment thus structured, the fastening bolt 232 is displaceable to the initial position and the connection start position at the time of connection to the second connector 14, wherefore effects similar to those of the first embodiment can be exhibited. Particularly, in the first embodiment, the C-ring 180 is non-displaceable in the vertical direction with respect to the fastening bolt 22, and the shield shell 68 is provided with the recess 138 to enable a displacement of the fastening bolt 22 to the initial position. In contrast, in the second embodiment, the shield shell 68 needs not be provided with the recess 138 and a change in the shape of the shield shell 68 is avoided by making the C-ring 180 displaceable in the vertical direction with respect to the fastening bolt 232.

### <Modifications>

Although the first and second embodiments have been described in detail as specific examples of the present disclosure above, the present disclosure is not limited by this specific description. Modifications, improvements and the like within a range in which the aim of the present disclosure can be achieved are included in the present disclosure. For example, the following modifications of the embodiments are also included in the technical scope of the present disclosure.

(1) The shapes of the first and second terminals 16, 18 in the above embodiments are merely illustrative, but not restrictive. That is, although the second terminal 18 includes the pin-shaped columnar connecting portion 188 and the first terminal 16 includes the tubular connecting portion 24 in the above embodiments, there is no limitation to this mode. A second terminal may be in the form of a flat tab as described, for example, in International Publication No. WO 2021/145197 and, in that case, a first terminal may include a substantially rectangular terminal insertion gap.

(2) Although the first housing 20 includes the first connector housings 66 made of insulating synthetic resin and the shield shell 68 made of metal and the shielding function is exhibited by the contact of the shield shell 68 and the casing 186 at the time of connecting the first connector 12, 230 and the second connector 14 in the above embodiments, there is no limitation to this mode. That is, the shielding function may not be exhibited in the connector assembly according to the present disclosure, and a shield shell, a shield bracket, a casing and the like may not be provided. In that case, a bolt insertion hole, into which a fastening bolt is inserted, may be provided in a first connector housing made of synthetic resin.

(3) Although the engaging protrusion projecting toward the outer peripheral surface from the fastening bolt 22, 232 is constituted by the C-ring 180, 234 in the above embodiments, there is no limitation to this mode. For example, an engaging protrusion may be provided to project toward an outer peripheral side from the outer peripheral surface of a fastening bolt after the fastening bolt is inserted into a bolt insertion hole. That is, an engaging protrusion may be constituted by a pin or the like inserted into a recess provided in the outer peripheral surface of the fastening bolt or an annular or an annular or pin-shaped engaging protrusion may be fixed to the outer peripheral surface of the fastening bolt after insertion into the bolt insertion hole.

### LIST OF REFERENCE NUMERALS

10 connector assembly
12 first connector (first embodiment)
14 second connector
16 first terminal
18 second terminal
20 first housing
22 fastening bolt
24 tubular connecting portion
26 first terminal body
28 clip spring
30 first peripheral wall portion
32 second peripheral wall portion
34 arcuate protrusion
36 linear contact portion
38 base end side plate portion
40 coated wire
42 wire fixing portion
44 core wire
46 insulation coating
48 tip side plate portion
50 through hole
52 stopper portion
54 coupling plate
56 pressing piece
58 bent part
60 insertion opening
62 through window
64 locking piece
66 first connector housing
68 shield shell
70 lower opening
72 front retainer
74 bolt insertion hole
76 terminal accommodating portion
78 upper wall portion
80 lower wall portion
82 left wall portion
84 right wall portion
86 front wall portion
88 wire pull-out opening
90 first connector housing body
92 first connector housing lid portion
94 lower window portion
96 insertion hole
97 supporting protrusion
98 lock protrusion
100 lock frame body
102 resilient piece
104 locking claw
106 upper wall portion
108 lower wall portion
110 left wall portion
112 right wall portion
114 front wall portion
116 partitioning portion
117 locking recess
122 through hole
124 inner tube portion
126 outer tube portion
128 waterproof rubber
130 lower opening (front opening)
132 upper opening (rear opening)
134 lower peripheral edge part (front peripheral edge part)
136 upper peripheral edge part (rear peripheral edge part)
138 recess
139 contact portion
140 lock claw portion
142 fixing portion
144 bolt
146 upper bottom wall portion
148 peripheral wall portion
150a, 150b through hole
154 waterproof rubber
156 back retainer
158 upper retainer
160 lower retainer
162 lock frame body
164 shield bracket
166 tubular wall portion
168 front projecting portion
170 crimp band
172 bolt head portion
174 inserting shaft portion
176 bolt-side screw portion
178 ring mounting groove
180 C-ring (engaging protrusion, ring member)
181 bottom surface
182 second housing
184 nut
186 casing
188 columnar connecting portion
190 resin cap
192 bolt insertion hole
194 through hole
196 peripheral wall portion
198 curved plate portion
200 outer wall portion
202 leg portion
204 bolt
206 waterproof rubber
208 rectangular plate portion
210 insertion hole
212 nut-side screw portion
218 upper opening
220 gap
230 first connector (second embodiment)
232 fastening bolt
234 C-ring (engaging protrusion, ring member)
236 ring mounting groove
238a lower end surface (front end surface in connection direction)
238b upper end surface (rear end surface in connection direction)

1. A first connector to be detachably connected to a second connector, comprising:
a first terminal to be connected to a second terminal provided in the second connector;
a first housing for accommodating and holding the first terminal; and
a fastening bolt held in the first housing, the fastening bolt being fastened to a nut provided in the second connector,
the first housing including a bolt insertion hole penetrating through the first housing in a connection direction of the first connector to the second connector,
the fastening bolt including a bolt head portion, an inserting shaft portion projecting forward in the connection direction from the bolt head portion and to be inserted into the bolt insertion hole, a bolt-side screw portion projecting forward in the connection direction from a tip of the inserting shaft portion and an engaging protrusion located on the tip side of the inserting shaft portion and projecting toward an outer peripheral side of the fastening bolt,
the bolt insertion hole including a front opening open forward in the connection direction and a rear opening open rearward in the connection direction,
the fastening bolt being displaceable by a predetermined dimension in the connection direction with respect to the bolt insertion hole between an initial position where a rearward displacement in the connection direction is restricted by the engaging protrusion engaging a front peripheral edge part, the front peripheral edge part being a peripheral edge part of the front opening, and a connection start position where a forward displacement in the connection direction is restricted by the bolt head portion engaging a rear peripheral edge part, the rear peripheral edge part being a peripheral edge part of the rear opening, the fastening bolt being inseparably assembled, and
the fastening bolt being arranged at the initial position by a tip of the bolt-side screw portion contacting an opening of the nut and displaced to the connection start position by the bolt-side screw portion of the fastening bolt being threadably engaged with a nut-side screw portion provided in the nut in a state where the first connector is temporarily fixed to the second connector and no contact pressure is generated between the first terminal and the second terminal.

2. The first connector of claim 1, wherein the first housing includes an insulating first connector housing and a shield shell made of metal and to be fixedly assembled with the first connector housing while covering the first connector housing, and the bolt insertion hole is provided in the shield shell.

3. The first connector of claim 1, wherein:
the engaging protrusion of the fastening bolt is non-displaceably provided,
a recess open in the connection direction is provided in the front peripheral edge part of the bolt insertion hole and a depth of the recess is set to the predetermined dimension, and
the fastening bolt is arranged at the initial position by the engaging protrusion contacting a bottom surface of the recess and the fastening bolt is arranged at the connection start position by the engaging protrusion being displaced toward an opening side of the recess and the bolt head portion contacting the rear peripheral edge part.

4. The first connector of claim 1, wherein:
an annular ring mounting groove open toward the outer peripheral side is provided on the tip side of the inserting shaft portion of the fastening bolt,
a ring member made of metal and cut in one place in a circumferential direction is mounted displaceably in the connection direction into the ring mounting groove to configure the engaging protrusion,
the first connector is temporarily fixed to the second connector and the tip of the bolt-side screw portion contacts the opening of the nut, whereby the ring member is locked to a front end surface in the connection direction of the ring mounting groove on the fastening bolt arranged at the initial position, and
the ring member moves toward a rear end surface in the connection direction of the ring mounting groove and the bolt head portion contacts the rear peripheral edge part on the fastening bolt threadably engaged with the nut and arranged at the connection start position.

5. The first connector of claim 1, wherein:
the fastening bolt is displaced to a connection completion position located forward in the connection direction by further threadably engaging the bolt-side screw portion with the nut-side screw portion from the connection start position, and
the first connector is completely fixed to the second connector with the fastening bolt arranged at the connection completion position.

6. A connector assembly, comprising:
the first connector of claim 1; and
a second connector to be detachably connected to the first connector,
the second connector including a second terminal to be connected to the first terminal, a second housing for accommodating and holding the second terminal and a nut to be fastened to the fastening bolt.
